(19) United States
(12) Patent Application Publication
(10) Pub. No.: US 2008/0084417 A1
(43) Pub. Date: Apr. 10, 2008

(54) Character input apparatus and program

(75) Inventors: Masaru Sawaki, Niwa-gun (JP); Yoshinori Watanabe, Chita-gun (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/905,620

(22) Filed: Oct. 2, 2007

(30) Foreign Application Priority Data
Oct. 5, 2006 (JP) 2006-274049

(51) Int. Cl. G06T 11/00

(52) U.S. Cl. 345/467

(57) ABSTRACT

A character input apparatus includes a display device, list display control means, a storage device, operation means, and retrieval means. The list display control means displays selectable characters in a one-dimensional character list display area defined in a character input screen. The list display control means is configured to display a certain number of characters in the character list display area. The storage device stores dictionary data. The operation means selects and inputs one of the characters. The retrieval means retrieves a character string from the dictionary data. The list display control means displays only an associated character in the character list display area in accordance with a retrieval by the retrieval means. Here, the associated character may follow the character string that has been already inputted. The list display control means omits a display of an other character other than the associated character.

### CROSS REFERENCE TO RELATED APPLICATION

This application is based on and incorporates herein by reference Japanese Patent Application No. 2006-274049 filed on Oct. 5, 2006.

### BACKGROUND OF THE INVENTION

1. Field of the Invention

A present invention relates to a character input apparatus and program that selects and inputs one of characters displayed on a character list display area of a display device.

2. Description of Related Art

For example, a vehicle navigation system carried in a car includes a main part, a display device, a position detector, a map data input device. The main part is provided with a microcomputer. The display device contains a full color liquid crystal display. The position detector includes a GPS receiver. The map data input device reads map data and destination data from a memory storage, such as a DVD. The vehicle navigation system performs a location function, a route guidance function, etc. Typically, the location function detects the present position of a vehicle, on which the navigation system is carried, to display the present position on top of a map (i.e., the present position overlapping the map) in the display device. The route guidance function searches for and guides a recommended route to the destination designated by a user.

In this case, methods for a user to set up a destination during the execution of the route guidance function includes searching a facility genre for the destination, searching an address or a telephone number for the destination, or inputting the name of the destination by a language (e.g., the Japanese kana syllabary). In the above input operation of the Japanese kana syllabary, the table (Japanese kana syllabary table) of input characters is displayed on the screen of the display device. By a touch sensitive screen input or a remote-control-unit operation, the user selects a character one by one that constitutes the destination name for input.

In a conventional character input apparatus, when the user inputs characters, the character string (item), which contains a string of the inputted characters at the head thereof, is searched from database of the memory storage. Then, the conventional character input apparatus usually displays only associated characters, which may follow the string of the already inputted characters. Also, the conventional character input apparatus makes a display color of the other characters darker (i.e., softens the color of the other characters) for an indication of non-input target. Alternatively, the conventional apparatus may omit the indication of the other characters (for example, refer to JP-A-2005-44220). This can facilitate an input operation for inputting characters for the user.

In order for the above-mentioned character input apparatus to display the table (Japanese kana syllabary table) of the input characters on the screen of the display device, the character input apparatus is required to have a comparatively large-sized display device (e.g., for a vehicle navigation system, a display device of seven inches). In contrast, by recent years, a display device of a vehicle navigation system may be required to be a comparatively small display device having a screen of 3.5 inches such that the display device can be provided in a combination meter (e.g., instrument panel) of a driver's seat. As a result, it may become impossible due to conditions, such as visibility, to display the whole table of the above-mentioned character on the comparatively small screen.

Thus, in the case of such a comparatively small display device, the one-dimensional character list display area that displays several characters (for example, 5 to 8 characters) is provided in the screen of the display device. Thus, it is possible to scroll and display the list of the input characters in the display area for selection of characters by user operation.

For example, the above-mentioned art is applied to a configuration of the above small character input screen such that only associated characters are displayed in a normal condition, and that the other characters other than the associated characters are displayed with a softened color. In this case, the user may have difficulty in identifying a character that is selectable for the next input if the user does not carefully look into the display. For example, this may happen when all the characters presently displayed in the one-dimensional character list display area are other than the input target (i.e., the associated characters), and have the softened color. Or, for another example, the above disadvantage may happen when all the characters displayed in the character list display area are associated characters, in contrast.

### SUMMARY OF THE INVENTION

The present invention is made in view of the above disadvantages. Thus, it is an objective of the present invention to address at least one of the above disadvantages.

To achieve the objective of the present invention, there is provided a character input apparatus, which includes a display device, list display control means, a storage device, operation means, and retrieval means. The display device is configured to display a character input screen. The list display control means scrolls and displays selectable characters in a one-dimensional character list display area defined in the character input screen. The list display control means is configured to display a certain number of characters in the character list display area. The storage device stores dictionary data having a certain number of words. The operation means selects and inputs one of the characters that are displayed in the character list display area. The retrieval means retrieves a character string from the dictionary data stored in the storage device. The character string is inputted by the operation means. The list display control means displays only an associated character in the character list display area in accordance with a retrieval by the retrieval means. Here, the associated character may follow the character string that has been already inputted. The list display control means omits a display of an other character other than the associated character.

### BRIEF DESCRIPTION OF THE DRAWINGS

The invention, together with additional objectives, features and advantages thereof, will be best understood from the following description, the appended claims and the accompanying drawings in which:

FIG. 1 is a block diagram showing a schematic configuration of a vehicle navigation system according to one embodiment of the present invention;

FIG. 2 is a front view of a combination meter;

FIGS. 3A-3D are diagrams each illustrating an example of a display of a character input screen;

FIG. 4 is a flow chart showing a procedure of a display control performed by a control circuit;

FIG. 5 is a diagram showing an example of a display of a character input screen according to another embodiments of the present invention; and

FIG. 6 is a diagram showing an example of a display of a character input screen according to still another embodiment.

### DETAILED DESCRIPTION OF PREFERRED EMBODIMENTS

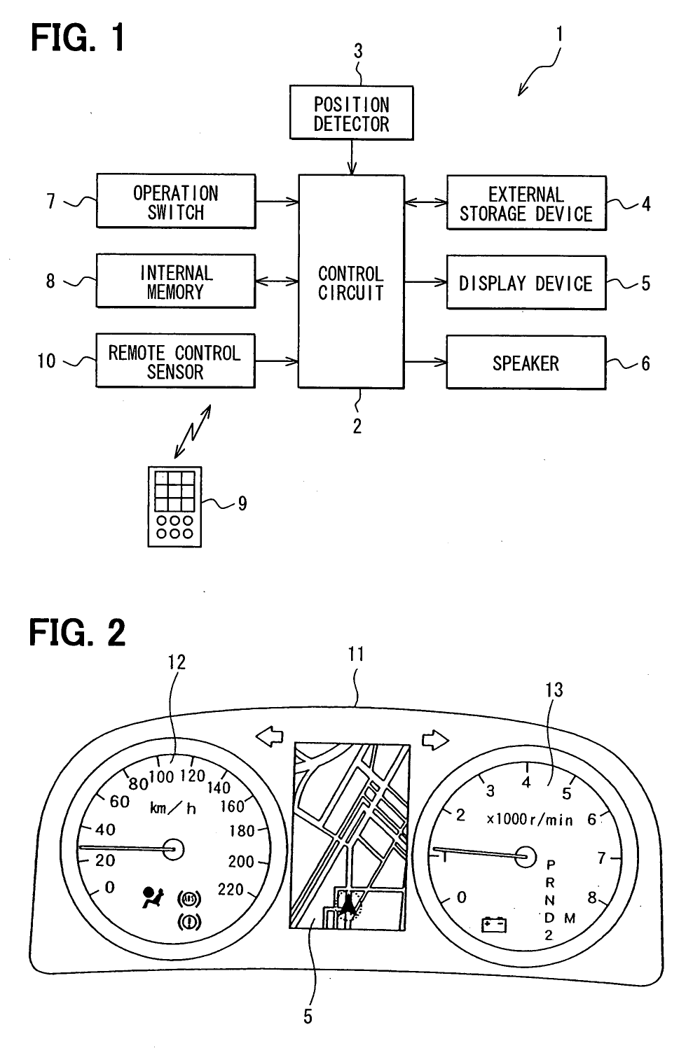

Hereafter, one embodiment of the present invention is described referring to an FIG. 1 to FIG. 4. The present embodiment is made by applying the present invention to a vehicle navigation system carried by vehicles, such as a car. In the present embodiment, a comparatively small display device is provided in a central part of an combination meter formed in the driver's seat portion of an instrument panel of a car.

First, the FIG. 1 shows a schematic electric structure of a vehicle navigation system 1 as a character input apparatus according to the present embodiment. The vehicle navigation system 1 includes a control circuit 2. Typically, the control circuit 2 mainly includes microcomputers, such as a CPU, a ROM, a RAM, and an I/O, to control the whole. The control circuit 2 is communicated with a position detector 3, an external storage device 4, a display device 5, a speaker 6, an operation switch 7, an internal memory 8, and a remote control sensor 10. Typically, the position detector 3 detects a present position of an own vehicle, on which the vehicle navigation system 1 is mounted. The external storage device 4 serves as a storage device storing data (e.g., database). The speaker 6 outputs sound. The internal memory 8 stores various programs and data items. The remote control sensor 10 receives signals from a remote control terminal 9 (remote control unit) for input.

The position detector 3 includes a GPS receiver, a gyro sensor, a G sensor (neither is illustrated) of well known such that the position detector 3 detects the present position of the own vehicle, a direction of movement of the own vehicle, and the like with high degree of accuracy based on the signal from the above components.

The external storage device 4 includes a storage medium and a drive device. Typically, the storage medium (e.g., a DVD, a hard disk, and the like) stores various kinds of data items, such as road map data and destination data (facility database) that is associated with the road map data. The drive device reads (retrieves) data from the storage medium. The external storage device 4 serves as database which stores dictionary data containing a lot of words (destination names, such as facility names).

The road map data includes data road geometry, the width of a street, a road name, a building, various facilities, name of a place, geographical feature, etc., and also includes data for reproducing the road map on the screen of the display device 5. The destination data includes information about transportation facilities (e.g., a station), other facilities (e.g., leisure facilities, accommodations, and public facilities), various kinds of stores (e.g., a retail store, a department store, a restaurant), residences, apartments, names of places, and the like. Also, the destination data includes data of addresses, telephone numbers, latitudes, longitudes, and the like of the above facilities and the like. At the same time, the destination data includes data for displaying landmarks which show respective facilities above the road map image on the screen of the display device 5.

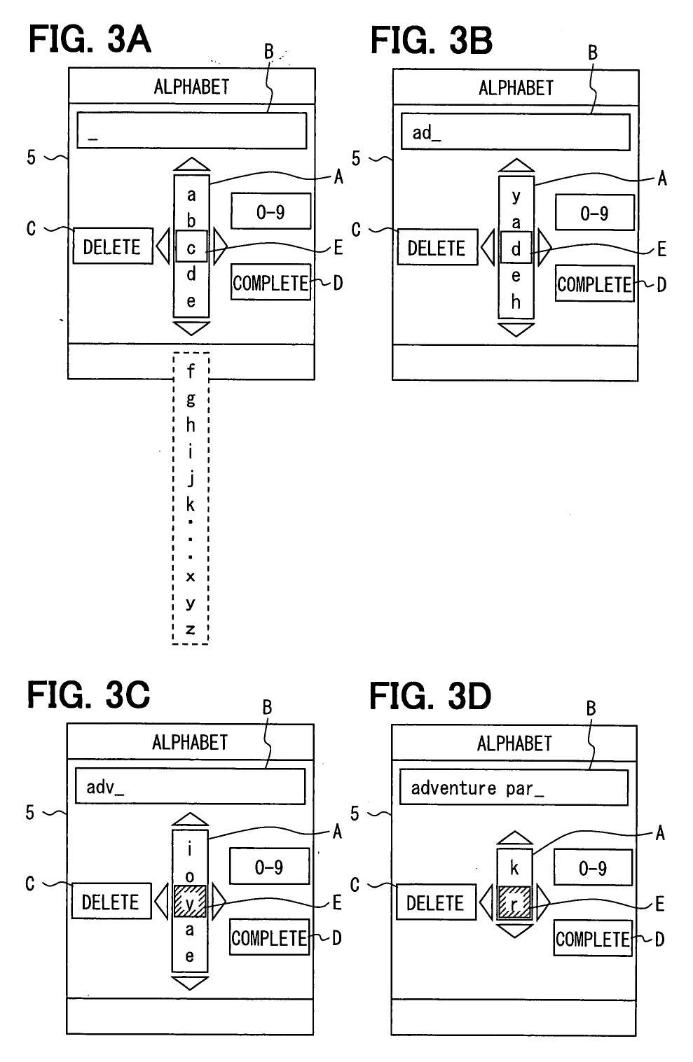

The display device 5 includes a TFT color liquid crystal display, for example. The TFT color liquid crystal display typically has a comparatively small screen (for example, 3.5 inches) of a slightly portrait format. For example, the small screen has a size longer in a longitudinal direction than that in the transverse direction. As shown in FIG. 2, the display device 5 is provided between a speedometer 12 and tachometer 13 at the central part of the combination meter 11. Navigation screens, such as a road map of the periphery of the present location of the own vehicle, are displayed on the screen of the display device 5. With it, a character input screen (refer to FIGS. 3A to 3D) is displayed at the time of a setup of a destination. The setup is described later in detail.

The operation switch 7 includes two or more mechanical switches formed in a position operable by the user. For example, the mechanical switches are provided at a position in the instrument panel, or in a steering wheel. Also, the operation switch 7 is provided with a cursor key, a determination key, and the like for vertically and horizontally moving a cursor on the screen of the display device 5. The remote control unit 9 is also provided with two or more keys to perform the similar function as the operation switch 7. The operation switches 7 and the remote control unit 9 serve as operation means.

The control circuit 2 realizes the location function that tells the present position of the own vehicle, by the software-based structure (i.e., by the execution of a program). With it, the control circuit 2 realizes the route guidance function that searches for the route to the designated destination, and provides guidance. The location function displays a road map on the display device 5 based on the road map data acquired from the external storage device 4 (or the internal memory 8). With it, the location function displays a present location mark, which shows a present position and a direction of movement of the own vehicle, on the road map based on detection by the position detector 3. At this time, a scale of the map to be displayed is changeable with an operation of the operation switch 7 (or the remote control unit 9) by the user.

The route guidance function automatically calculates a recommended running path (route) to the destination designated by the user from the place of departure (the present location) of the own vehicle, for example, by using a well-known Dijkstra method. Thus, the route guidance function provides guidance of the calculated route to the destination. In addition to the above road map and the present location mark, in the route guidance, the recommended route is displayed on the screen of the display device 5 in a softened color. Along with the above, a guidance sound is outputted through the speaker 6 at a necessary time. When the destination exists in the screen, a destination mark (not shown) is also displayed.

Methods for a user to set up the destination during the execution of the route guidance function includes searching a facility genre for the destination, searching an address or a telephone number for the destination, and inputting the name of the destination by alphabetical characters. The user selects a required mode by the operation of the operation switch 7 (or the remote control unit 9). In one of the modes (i.e., the character input operation mode), the control circuit 2 displays the character input screen on the screen of the display device 5. By the operation of the operation switch 7 (or the remote control unit 9) by the user who looks at the character input screen, the user selects and inputs a character one by one that constitutes the destination name.

At this time, as shown in FIGS. 3A to 3D, an one-dimensional character list display area A surrounded by the longwise frame is provided in the central part in the character input screen of the display device 5. An oblong input character string display area B is formed in the upper part of the character input screen. Icons (keys) C and D, such as “delete” and “complete”, are displayed on the left part and the right part of the screen, respectively.

The input associated character that includes alphabets of a certain number of characters (five characters in this case) are displayed on the character list display area A. The control circuit 2 displays input associated characters in the character list display area A in the certain order (for example, an alphabetical order). Also, the control circuit 2 is configured to scroll the displayed characters (list) in a vertical direction (longitudinal direction of the screen) in response to the operation of the operation switch 7 (or remote control unit 9) by the user. A selection cursor E is displayed at the fixed position in the character list display area A. For example, in the present embodiment, the fixed position is a position corresponding to the third character from a top.

In the above manner, by the operation of the cursor key of the operation switch 7 (or remote control unit 9), the user scrolls the displayed characters so that the character to input comes to the position of the selection cursor E in the character list display area A. One character is selected (inputted) by carrying out ON operation of the determination key in the above state. By repeating the above operation in sequence, a certain word (e.g., a name of the destination) can be inputted. At this time, the string of the already inputted characters is displayed on the input character string display area B. After the input is completed, the user moves the cursor over the icon of “complete” by the operation of the cursor key, and performs the ON operation of the determination key to complete the destination input.

As is described later, the control circuit 2 searches the destination data for the destination name that contains the string of the inputted characters (i.e., the character string) at the head in the input character string display area B by using the software configuration (execution of the character input operation program), when there is an input of the character in the character input operation mode. Then, the control circuit 2 displays only the associated characters, which may follow the string of the already inputted characters, on the character list display area A, and omits the display of the other characters, which may not. When the control circuit 2 displays only the associated characters on the character list display area A according to the present embodiment, the displayed associated characters are positioned or arranged close to each other such that the control circuit 2 usually displays five characters (refer to FIGS. 3B and 3C) in the character list display area A. Therefore, the control circuit 2 serves as retrieval means and list display control means by the execution of the program.

At the time of the start of a following operation for selecting a character, the control circuit 2 displays a character selected in the preceding operation in a position corresponding to the selection cursor E in the character list display area A (refer to FIGS. 3B and 3C). In this case, when the precedingly selected character is different from the associated characters (i.e., when the associated characters do not include the precedingly selected character), the precedingly selected character is displayed in a condition different from that, in which the associated characters are displayed. For example, the precedingly selected character may be indicated in the softened color (see FIGS. 3C, 3D). Furthermore, the control circuit 2 reduces a size of the character list display area A in accordance with the number of the associated characters when the number of the associated characters is less than a maximum number of characters that can be displayed in the character list display area A (see FIG. 3D). Here, the maximum number of characters is five characters in the present embodiment.

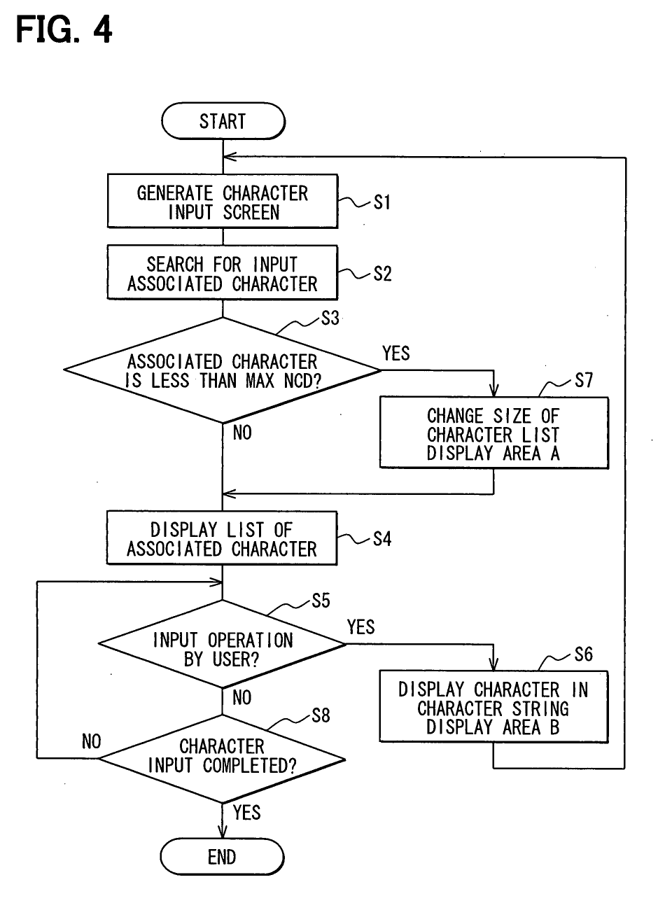

Next, the operation of the above structure is described referring to FIGS. 3A to 4. FIG. 3 shows an embodiment (an example) of the character input screen in the display device 5. A flow chart shown in FIG. 4 shows the procedure of the process performed by the control circuit 2 for displaying the character input screen on the screen of the display device 5 in the character input operation mode.

Specifically, at step S1, the character input screen is generated first, and input associated characters are searched at step S2. At step S3, it is determined whether the number of input associated characters is less than the maximum number of characters for display (Max. NCD). In the present embodiment, the Max NCD is five characters. When the number of input associated characters is equal to or more than the maximum number of characters for display (i.e., NO at step S3), a list of characters to be displayed on the character list display area A is generated and displayed at step S4.

Only the associated characters searched at step S2 are arranged in the alphabetical order in the list of characters displayed on the character list display area A. Here, the associated characters are characters that may follow the string of already inputted characters displayed in the input character string display area B or characters that may follow the character string that has been already inputted. The other characters other than the associated characters are omitted from the list of the characters displayed on the character list display area A. At step S5, it is determined whether there has been any operation of the character input by the user. When there is the character input operation (YES at step S5), the character is displayed in the input character string display area B at step S6, and control returns to step S1.

Here, the operation is described referring to the example of FIGS. 3A to 3D. In an initial state of the character input operation mode, as shown in FIG. 3A, “a”, “b”, “c”, “d”, and “e”, which are the first five characters in the alphabetical order, are displayed on the character list display area A. The selection cursor E corresponds to the third character from the top “c”. The user scrolls the character list (i.e., the list of the characters) by using the up-and-down operation of the cursor key of the operation switch 7 (or the remote control unit 9) so that a character to input (to select) comes to the position corresponding to the selection cursor E. Then, the user performs the ON operation of the determination key in the above state.

When the user wants to input “a” in the state of FIG. 3A, for example, the user downwardly scrolls the display of characters by two characters amount by operating the cursor key, such that “a” comes to the position corresponding to the selection cursor E. Then, the ON operation of the determination key is carried out in the above state. Then, the character of “a” is displayed at the head (left end) of the input character string display area B. Subsequently, when the user selects (inputs) the character of “d” by the same operation, the character string of “ad” is formed and displayed in the input character string display area B as shown in FIG. 3B.

In the state shown in FIG. 3B (the input up to “d” has been completed), only the associated characters are displayed on the character list display area A. For example, characters other than the associated characters (e.g., “b”, “c”, “f”), which may not follow the string of the already input characters “ad”, are omitted. Although not shown in the flow chart in FIG. 4, “d”, which is the character selected in the preceding input operation, is displayed at the position corresponding to the selection cursor E. When the user inputs “v” next, “adv” is displayed on the input character string display area B as shown in FIG. 3C. Also, in FIG. 3C, only the next associated characters are arranged close to each other to be displayed on the character list display area A so that the precedingly selected character of “v” is located in the position of the selection cursor E. However, in a case where “v” is not included in the next associated characters, the character “v” may be displayed in the softened color, for example. That is, the character “v” may be displayed by a pale color. For convenience, in FIG. 3, hatching is drawn on the character “v” to indicate the character of the pale color.

Thus, when the user repeats the character input operation, the number of the associated characters, which comes next, decreases gradually. Returning to FIG. 4, when the number of the associated characters searched at step S2 becomes less than the maximum number (i.e., five) of characters for display (YES at step S3), at step S7, the size of the character list display area A is changed according to the number of associated characters to be displayed. In the example shown in FIG. 3D, only two characters are displayed on the character list display area A. In this case, the size of the character list display area A is reduced to a size for two characters.

When the user completes the character input operation, the user moves the cursor over the icon D of “complete” by the operation of the cursor key and performs the ON operation of the determination key. Then, the control circuit 2 determines that the character input operation has been completed (YES at step S8), and ends the processing of the character input operation. Consequently, the control circuit 2 displays the map corresponding to the destination inputted as above. Along with it, the control circuit 2 demands the user to operate a confirmation (setup) of the destination, and then performs the route search and the route guidance from the present location to the destination.

In the present embodiment as above, an apparatus includes the comparatively small display device 5, and displays in the one-dimensional character list display area A only the associated character that may follow the string of the already inputted characters. Here, the character list display area A is capable to display a small number of characters. Also, the apparatus omits the display of the other character other than the associated character. Therefore, the user clearly knows which character can be inputted next. As a result, even in the configuration, in which a character is selected and inputted one by one from the characters displayed in the character list display area A that is configured to display characters of a certain number, the user can more easily distinguish the associated character from the other character. Thus, the operability of the character input operation can be advantageously improved.

Typically in the present embodiment, the associated characters are arranged close to each other with a smaller space between the associated characters in the character list display area A. As a result, many associated characters as possible can be always displayed in the character list display area A, and still more, the user is reliably limited from selecting a character that cannot be inputted.

The selection cursor E for selection is provided in the fixed position in the character list display area A. Therefore, the user can perform selection operation of a character comfortably, and thereby the operability becomes more improved. At the time of the start of the selection operation of the following character, the precedingly selected character is displayed at the position of the selection cursor E in the character list display area A. Therefore, the character in the position of the selection cursor E is limited from arbitrarily changing. Also, it can be efficiently understood how much of the string of the characters to be inputted has been inputted by the user. Thus, the operability can be improved.

When the precedingly selected character is not included in the associated characters, the precedingly selected character is displayed in a different form (e.g., in the pale color) from the associated characters. Therefore, the display is comfortable for the user. When the number of the associated characters decreases, the size of the character list display area A is reduced according to the number in the present embodiment. Therefore, a small number of characters can be easier to be seen.

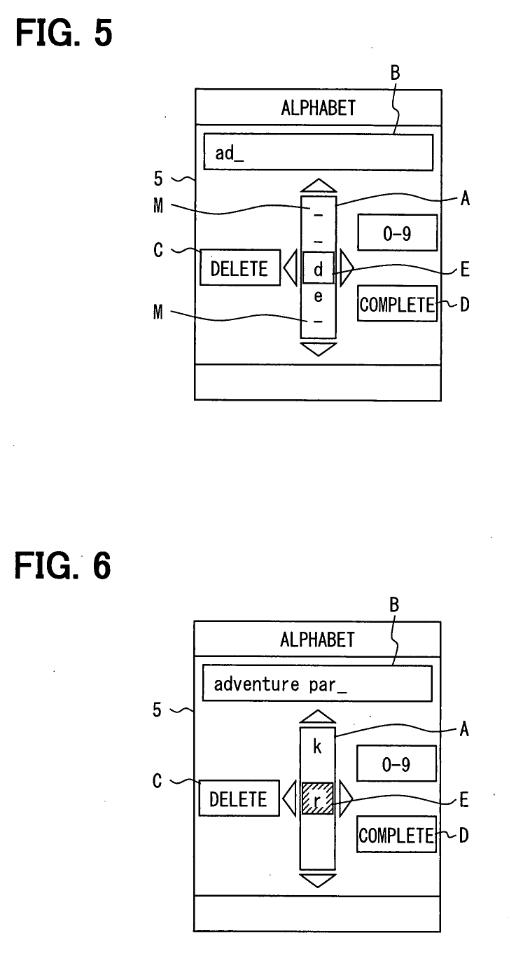

FIG. 5 shows another embodiments of the present invention, and different points from the above embodiment is described below. Similar components of a character input apparatus and program of the present embodiment, which are similar to the components of the character input apparatus and program of the above embodiment, will be indicated by the same numerals. That is, in the above embodiment, when only the associated characters are displayed on the character list display area A and the other characters other than the associated characters are omitted, the associated characters are arranged close to each other in the alphabetical order for display. In the present embodiment, characters are displayed on the character list display area A also in a specific order (alphabetical order), but each of the other characters other than the associated characters is replaced with a certain omission mark (e.g., a mark M of “-”) for display. In FIG. 5, “b”, “c”, and “f” are each replaced with the mark “-”, for example.

This also enables the user to distinguish the associated character from the other character similar to the above embodiment. Consequently, the effect that the operability of the character input operation can be improved is acquired. Also, characters are displayed such that the user can more easily determine which character is omitted and thereby cannot be inputted. Thus, this can reliably prevent the user from selecting a character that cannot be inputted.

FIG. 6 shows still another embodiment of the present invention. Similar components of a character input apparatus and program of the present embodiment, which are similar to the components of the character input apparatus and program of the above embodiment, will be indicated by the same numerals. In the present embodiment, when the number of associated characters becomes less than the number which can be displayed on the character list display area A, the size of the character list display area A is kept as it is and a space between each associated character is made wider than usual, instead of making the size of the character list display area A smaller according to the number of associated characters. Thereby, the small number of characters can be displayed on the character list display area A in an easy-to-see manner. Typically, the usual case includes a case, in which the character list display area A is sized such that five characters are displayed in the character list display area A, in the above embodiments.

The present invention is not limited to each of the above embodiment, and, for example, the below expansion and modification can be made. The order of the character displayed on the character list display area A is fixed to the alphabetical order in the above embodiment. However, for example, when only the associated characters are displayed on the character list display area A, the associated characters are rearranged on the character list display area A in decreasing order of the number of associated words in the dictionary data. Here, typically, the an associated word may be made using the string of already inputted characters in the input character string display area B. Alternatively, in the above case, the associated characters may be rearranged on the character list display area A in an decreasing order of the frequency of appearance in the past input operation record. According to the above, when the number of associated characters has decreased comparatively, the selection of the character to come next can be quickly performed, and therefore, the operability can be improved. Typically, the past input operation record includes a history of associated characters that have been inputted in the past.

In the above embodiments, examples of English language are described. However, the present invention can be modified and carried out according to the language (language character of the language of each country) for use. When displaying the other language character other than alphabet, various modifications may be employed. For example, the character list display area A may be formed into an oblong field that extends transversely to corresponding to the feature of the other language character. Also, the omission mark M may be alternatively “x” or “O”.

In addition, the present invention is not limited to the vehicle navigation system. For example, the present invention may be applicable to a character input apparatus at large, such as information machines and equipments provided with comparatively small display devices. The information machines and equipments include a pocket telephone, a handheld card reader, an optical information reader, a digital camera, a small electronic dictionary, and a PDA. Also, various changes are possible on the screen configuration of the character input screen, and on the whole hardware configurations. As long as the present invention does not deviate from a gist, the present invention can be changed suitably and carried out.

Additional advantages and modifications will readily occur to those skilled in the art. The invention in its broader terms is therefore not limited to the specific details, representative apparatus, and illustrative examples shown and described.

What is claimed is:

1. A character input apparatus comprising:
a display device configured to display a character input screen;
list display control means for scrolling and displaying selectable characters in a one-dimensional character list display area defined in the character input screen, the list display control means being configured to display a certain number of characters in the character list display area;
a storage device storing dictionary data having a certain number of words;
operation means for selecting and inputting one of the characters that are displayed in the character list display area; and
retrieval means for retrieving a character string from the dictionary data stored in the storage device, the character string being inputted by the operation means, wherein:
the list display control means displays only an associated character in the character list display area in accordance with a retrieval by the retrieval means, wherein the associated character may follow the character string that has been already inputted; and
the list display control means omits a display of an other character other than the associated character.

2. The character input apparatus according to claim 1, wherein:
the list display control means displays the characters in the character list display area in a predetermined order; and
the list display control means displays the associated characters arranged close to each other.

3. The character input apparatus according to claim 1, wherein:
the list display control means displays the characters in the character list display area in a predetermined order; and
the list display control means replaces the other character with a certain mark in order to omit the display of the other character.

4. The character input apparatus according to claim 1, wherein:
the list display control means displays a selection cursor for selection at a fixed position in the character list display area; and
the list display control means is configured to scroll the characters at the position of the selection cursor in accordance with an operation of the operation means.

5. The character input apparatus according to claim 4, wherein the list display control means displays a precedingly selected one of the characters at the position of the selection cursor in the character list display area when the operation means starts selecting a next one of the characters.

6. The character input apparatus according to claim 5, wherein the list display control means displays the precedingly selected one of the characters in a condition different from a condition, in which the associated character is displayed, when the precedingly selected one of the characters is other than the associated character.

7. The character input apparatus according to claim 1, wherein the list display control means arrange the associated character in the character list display area in a decreasing order of a number of associated words in the dictionary data when the list display control means only displays the associated character in the character list display area.

8. The character input apparatus according to claim 1, wherein the list display control means arranges the associated character in an decreasing order of a frequency of appearance in a past input record when the list display control means only displays the associated character in the character list display area.

9. The character input apparatus according to claim 1, wherein the list display control means reduces a size of the character list display area in accordance with a number of the associated characters when the number of the associated characters is less than the certain number of characters that the list display control means is able to display in the character list display area.

10. The character input apparatus according to claim 1, wherein the list display control means arranges the associated characters in the character list display area such that a space between each of the associated characters is made wider than usual when a number of the associated characters is less than the certain number of characters that the list display control means is able to display in the character list display area.

11. The character input apparatus according claim 1, wherein:
the other character generates a certain word; and
the certain word is different from the words in the dictionary data.

12. The character input apparatus according claim 1, wherein the character string is formed when the operation means inputs the one of the characters.

13. A program stored in a computer readable medium for a character input apparatus, wherein the character input apparatus includes:
a display device configured to display a character input screen;
a storage device storing dictionary data having a certain number of words; and
operation means for selecting and inputting one of characters displayed in a character list display area defined in the character input screen, the program comprising:
making the character input apparatus function as retrieval means for retrieving a character string from the dictionary data stored in the storage device, the character string being inputted by the operation means; and
making the character input apparatus function as list display control means for defining the character list display area in the character input screen, the list display control means being configured to scroll and display selectable characters in the character list display area, the character list display area being one dimension, the character list display area being configured to display a certain number of characters, the list display control means displaying only an associated character in the character list display area in accordance with a retrieval by the retrieval means, the list display control means omitting a display of an other character other than the associated character, wherein the associated character may follow the character string that has been already inputted.

14. The program according to claim 13, wherein:
the other character generates a certain word; and
the certain word is different from the words in the dictionary data.
